(19) United States
(12) Patent Application Publication
(10) Pub. No.: US 2017/0297228 A1
(43) Pub. Date: Oct. 19, 2017

(54) System To Assist Thermoforming Of Non-Woven Fabrics

(71) Applicant: INNOVATIVE MOLD SOLUTIONS, INC., Leominster, MA (US)

(72) Inventors: Derek Helmer, Groton, MA (US); Sean Wright, Holden, MA (US); Gary Dix, Jefferson, MA (US); Paul Boudreau, Princeton, MA (US)

(73) Assignee: INNOVATIVE MOLD SOLUTIONS, INC., Leominster, MA (US)

(21) Appl. No.: 15/099,777

(22) Filed: Apr. 15, 2016

(51) Int. Cl. B29B 13/02

(52) U.S. Cl. CPC B29B 13/023

(57) ABSTRACT

A system and method for thermoforming of non-woven fabric is presented. The system includes an air supply, a heating system in fluid communication with the air supply, a pressure and flow equalization element in fluid communication with the heating system, electrical controls in communication with the heating system and the pressure and flow equalization element, a pneumatic element in fluid communication with the pressure and flow equalization element, and a forming head for receiving a thermoformable non-woven fabric and for thermoforming said thermoformable non-woven fabric into a desired shape. The thermoforming process is a two-stage process, a first stage comprises a pre-heat stage wherein a heated flow of air is directed onto the thermoformable non-woven fabric and the second stage comprises flowing a continuous amount of air to increase an amount of heat available to the thermoformable non-woven fabric during thermoforming.

### BACKGROUND

Single-cup brewing devices are designed to quickly brew a fresh cup of roast and ground coffee using a single serve beverage pod. Such systems allow the consumer to rapidly make an individual cup of coffee by way of a beverage pod, rather than brewing an entire pot and wasting a portion of it if only a single cup is desired. Because of such features, many consumers prefer the ease and convenience of using one of the various single-cup brewing devices currently on the market.

The beverage pods used in such single serve brewing devices include a filter. Non-woven fabrics can be used for a variety of applications including filtration. In order to achieve the porosity and shape required for some applications, the fabric is required to be thermoformed.

### SUMMARY

While single-cup brewing devices may offer the convenience consumers are looking for, the single serve beverage pods such as those explained above suffer from a variety of deficiencies. One such deficiency is that the thermoforming process forces the fabric material to be stretched past its normal fracture point resulting in a failed finished product. Another deficiency is the introduction of biocompostable resins further constricts the thermoforming process parameters. Compostable materials typically have a low melting point and do not accept or release heat effectively. For an item to be marked compostable, there must be scientific evidence that the materials in the item break down, or become part of, usable compost in a safe and timely manner in an appropriate composting facility or home compost pile.

Another deficiency with existing thermoforming processes is that disposable single serve beverage pods produce a staggering volume of non-recyclable refuse that is currently only able to be disposed of in landfills. A mix of materials does not provide a realistic recycling solution and since a non-compostable filter is used in the manufacture of the beverage pod, a biodegradable solution is not possible. Traditional machines used to form the beverage pods do not provide for thermoforming of non-woven fabrics used as a filter element. In particular, the filter built into the beverage pods is not biocompostable. Embodiments of the invention significantly overcome such deficiencies.

A system and method for thermoforming of non-woven fabric is presented. The system includes an air supply, a heating system in fluid communication with the air supply, a pressure and flow equalization element in fluid communication with the heating system, electrical controls in communication with the heating system and the pressure and flow equalization element, a pneumatic element in fluid communication with the pressure and flow equalization element, and a forming head for receiving a thermoformable non-woven fabric and for thermoforming said thermoformable non-woven fabric into a desired shape which can be incorporated as a filter element as part of a beverage pod.

The thermoforming process is a two-stage process, a first stage comprises a pre-heat stage wherein a heated flow of air is directed onto the thermoformable non-woven fabric and the second stage comprises flowing a continuous amount of air to increase an amount of heat available to the thermoformable non-woven fabric during thermoforming. In one particular application, the thermoformable non-woven fabric is stretched to 150% of its original size during the thermoforming operation. The heat applied needs to be high enough to allow the material to stretch but not high enough to melt the fabric fibers.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. The drawings are not necessarily to scale, emphasis instead being placed upon illustrating the principles of the invention.

FIG. 1 comprises a block diagram of a system used to thermoform non-woven fabrics which are compostable in accordance with a particular embodiment of the present invention.

FIG. 2 is a flow diagram of a particular method for thermoforming non-woven fabrics in accordance with a particular embodiment of the present invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

Polymeric materials change properties when subjected to elevated temperatures. Existing processes rely on contact heat during the forming process to achieve the desired results. Normally a mandrel is heated to a set temperature and the cycle time of the process is limited to the ability of the mandrel to transfer heat to the fabric and stretch the material while traversing the desired distance of forming.

The presently described method and apparatus for thermoforming non-woven fabrics is designed to apply a controlled volume and temperature of heated air to the material to be formed in two stages. The first stage is pre-heat where a heated flow of air is directed on the fabric in the area that will be formed. The second stage is a continuous flow of air during forming to increase the heat available to the fabric and encourage a successfully formed result.

The beverage pod filter is compostable in household, municipal or industrial compost facilities. For an item to be marked compostable there must be scientific evidence that the materials in the item break down, or become part of, usable compost in a safe and timely manner in an appropriate composting facility or home compost pile. Compostable items must completely break down and not release any metals or toxins into the compost.

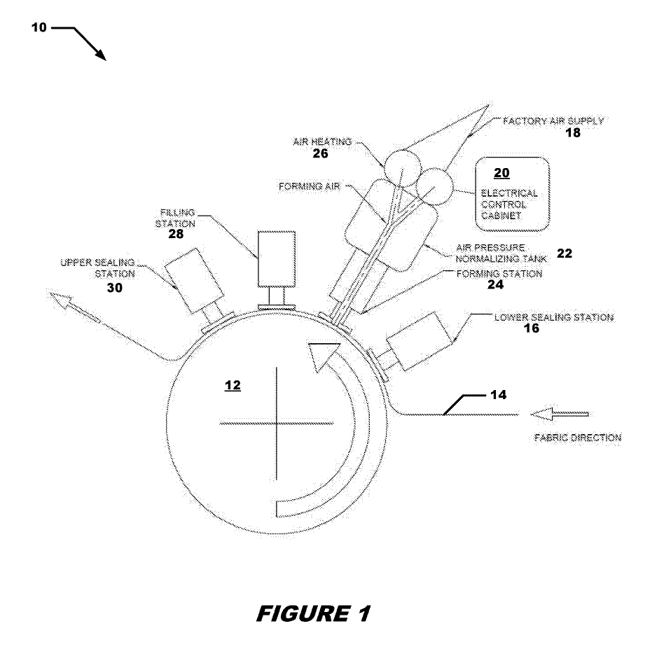

Referring to FIG. 1, a system 10 for thermoforming non-woven fabric is shown. System 10 is comprised of several components. These components of a system for thermoforming of non-woven fabric comprise an air supply 18, a heating system 26 in fluid communication with the air supply, and a pressure and flow equalization element 22 in fluid communication with the heating system.

The system 10 further includes electrical controls 20 in communication with the heating system and the pressure and flow equalization element, and a forming head 24 in fluid communication with the pressure and flow equalization element for receiving a thermoformable non-woven fabric and for thermoforming the thermoformable non-woven fabric into a desired shape.

The system includes a first stage for thermoforming the thermoformable non-woven fabric. The first stage comprises a pre-heat stage wherein a heated flow of air is directed onto the thermoformable non-woven fabric in area of the thermoformable non-woven fabric that will be thermoformed. The system also includes a second stage for thermoforming said thermoformable non-woven fabric resulting in a thermoformed non-woven fabric. The second stage comprises flowing a continuous amount of air to increase an amount of heat available to the thermoformable non-woven fabric during thermoforming.

The system 10 includes a lower sealing station for sealing said thermoformable non-woven fabric to a beverage pod ring prior to the thermoforming of the thermoformable non-woven fabric. The system further comprises a filling station 28 for filling the thermoformed non-woven fabric with a material. The system also comprises an upper sealing station 30 for sealing the material within the thermoformed non-woven fabric. Additionally the system includes a drum 12 for moving the thermoformable non-woven fabric from the lower sealing station to the forming head, for moving the thermoformed non-woven fabric from the forming head to the filling station and for moving the thermoformed non-woven fabric from the filling station to the upper sealing station. Further, in a particular embodiment, the thermoformable non-woven fabric is biocompostable.

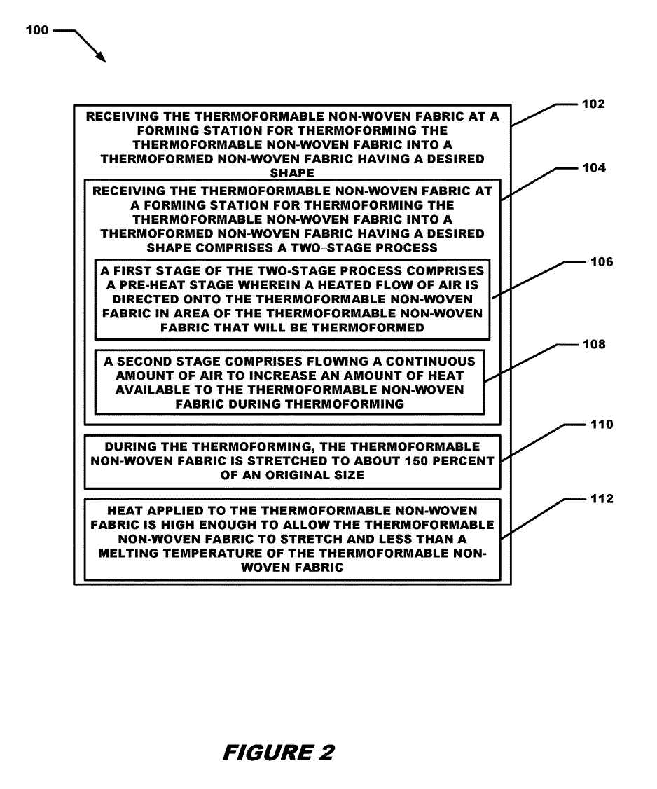

A flow diagram of a particular embodiment of the presently disclosed method is depicted in FIG. 2. The rectangular elements are herein denoted “processing blocks”. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 2, a flow diagram of a particular embodiment of a method 100 for thermoforming non-woven fabrics is shown. Method 100 begins with processing block 102 which discloses receiving the thermoformable non-woven fabric at a forming station for thermoforming the thermoformable non-woven fabric into a thermoformed non-woven fabric having a desired shape. Processing block 104 recites the receiving the thermoformable non-woven fabric at a forming station for thermoforming the thermoformable non-woven fabric into a thermoformed non-woven fabric having a desired shape comprises a two-stage process. As shown in processing block 106, a first stage of the two-stage process comprises a pre-heat stage wherein a heated flow of air is directed onto the thermoformable non-woven fabric in area of the thermoformable non-woven fabric that will be thermoformed. As shown in processing block 108, a second stage comprises flowing a continuous amount of air to increase an amount of heat available to the thermoformable non-woven fabric during thermoforming. Processing block 110 discloses during the thermoforming, the thermoformable non-woven fabric is stretched to about 150 percent of an original size. Processing block 112 states during the thermoforming, heat applied to the thermoformable non-woven fabric is high enough to allow the thermoformable non-woven fabric to stretch and less than a melting temperature of the thermoformable non-woven fabric.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

What is claimed is:

1. A system for thermoforming of non-woven fabric comprising:
a forming head for receiving a thermoformable non-woven fabric and for thermoforming said thermoformable non-woven fabric into a desired shape, said forming head including a first stage and a second stage.

2. The system of claim 1 wherein said first stage comprises a pre-heat stage wherein a heated flow of air is directed onto said thermoformable non-woven fabric in area of said thermoformable non-woven fabric that will be thermoformed.

3. The system of claim 1 wherein said second stage comprises flowing a continuous amount of air to increase an amount of heat available to said thermoformable non-woven fabric during thermoforming.

4. The system of claim 1 wherein during said thermoforming, said thermoformable non-woven fabric is stretched to about 150 percent of an original size.

5. The system of claim 1 wherein during said thermoforming, heat applied to said thermoformable non-woven fabric is high enough to allow said thermoformable non-woven fabric to stretch and less than a melting temperature of said thermoformable non-woven fabric.

6. The system of claim 1 wherein said thermoformable non-woven fabric is biocompostable.

7. A method of thermoforming a non-woven fabric comprising:
receiving the thermoformable non-woven fabric at a forming station for thermoforming said thermoformable non-woven fabric into a thermoformed non-woven fabric having a desired shape.

8. The method of claim 7 wherein said receiving the thermoformable non-woven fabric at a forming station for thermoforming said thermoformable non-woven fabric into a thermoformed non-woven fabric having a desired shape comprises a two-stage process.

9. The method of claim 8 wherein a first stage of said two-stage process comprises a pre-heat stage wherein a heated flow of air is directed onto said thermoformable non-woven fabric in area of said thermoformable non-woven fabric that will be thermoformed.

10. The method of claim 9 wherein a second stage comprises flowing a continuous amount of air to increase an amount of heat available to said thermoformable non-woven fabric during thermoforming.

11. The method of claim 7 wherein during said thermoforming, said thermoformable non-woven fabric is stretched to about 150 percent of an original size.

12. The method of claim 7 wherein during said thermoforming, heat applied to said thermoformable non-woven fabric is high enough to allow said thermoformable non-woven fabric to stretch and less than a melting temperature of said thermoformable non-woven fabric

13. The method of claim 7 wherein said receiving thermoformable non-woven fabric comprises receiving thermoformable non-woven fabric that is biocompostable.
